(19) United States
(12) Patent Application Publication
(10) Pub. No.: US 2011/0023841 A1
(43) Pub. Date: Feb. 3, 2011

(54) METHOD FOR OPERATING A COMBUSTION UNIT AND A COMBUSTION UNIT

(75) Inventors: Helmut Ucke, Velpke (DE); Bernhard Reintanz, Wolfhagen (DE)

Correspondence Address: ROBERTS MLOTKOWSKI SAFRAN & COLE, P.C.;Intellectual Property Department, P.O. Box 10064, MCLEAN, VA, 22102-8064, US

(73) Assignee: INNOVATIONEN ZUR VERBRENNUNGSTECHNIK GMBH, Wolfsburg (DE)

(21) Appl. No.: 12/599,708

(22) PCT Filed: May 8, 2008
(86) PCT No.: PCT/EP08/03688

§ 371 Date: Oct. 19, 2010

(30) Foreign Application Priority Data
May 11, 2007 (DE) 10 2007 022 734.7
Jul. 13, 2007 (DE) 10 2007 033 157.8
Nov. 8, 2007 (DE) 10 2007 053 621.8

(51) Int. Cl. F02M 25/00

(52) U.S. Cl. 123/568.12; 123/568.15

(57) ABSTRACT

A method for operating a combustion unit (1), a fuel (6) being burned with an oxygen-containing carrier gas (7) in at least one combustion space (2) with the release of an exhaust gas flow (8), ambient air (10) being separated into a product gas (12) which is enriched with oxygen and into exhaust air (13) enriched with nitrogen, a gas flow (9) being separated from the exhaust gas flow (8) and returned to the combustion space (2), the returned gas flow (9) being mixed with a gas flow (12a) of the product gas (12) to form a carrier gas (7). The carrier gas (7) and fuel (6) are supplied separately to the combustion space (2). The argon concentration in the returned gas flow (9) and/or in the carrier gas (7) is measured.

### BACKGROUND OF THE INVENTION

1. Field of Invention

The invention relates to a method for operating a stationary or mobile combustion unit, a fuel being burned with an oxygen-containing carrier gas in at least one combustion space with the release of an exhaust gas flow, ambient air being separated into a product gas which is enriched with oxygen and into exhaust air enriched with nitrogen. From the exhaust gas flow, a gas flow is separated and returned to the combustion space, the returned gas flow being mixed with a gas flow of the product gas to form a carrier gas and the carrier gas and fuel being supplied separately to the combustion space.

Moreover, this invention relates to a stationary or mobile combustion unit with at least one combustion space, at least one gas separation means, at least one mixing chamber and with at least one gas return means, a fuel being burned in the combustion space with an oxygen-containing carrier gas and with the release of an exhaust gas flow, ambient air in the gas separation means being separated into an oxygen-enriched product gas and exhaust air enriched with nitrogen, a gas flow being separated from the exhaust gas flow by means of the gas return means and returned to the combustion space. The returned gas flow in the mixing chamber is mixed with a gas flow of product gas to form the carrier gas, and the carrier gas and the fuel being supplied separately to the combustion space.

2. Description of Related Art

U.S. Pat. No. 3,817,232 discloses a process for operating an internal combustion engine of a motor vehicle in which a fuel with an oxygen-containing carrier gas is burned in a combustion space of the internal combustion engine with the release of an exhaust gas flow. The carrier gas is composed of an oxygen-enriched product gas flow and a returned partial flow of exhaust gas. Preferably, the oxygen-enriched product gas flow and the returned exhaust gas flow are mixed in a ratio which corresponds to the ratio of oxygen to nitrogen in the ambient air. Molecular sieves are used for oxygen enrichment.

### SUMMARY OF THE INVENTION

The object of this invention is to develop the method which is known from U.S. Pat. No. 3,817,232 and to provide a method and combustion unit of the initially described type which are intended to enable largely complete combustion of fuels at high efficiency of the combustion unit and with low pollutant formation and very highly reduced nitrogen oxide formation.

This object is achieved in a method of the initially mentioned type in that the argon concentration in the returned gas flow and/or in the carrier gas is measured. Thus, the combustion unit according to the invention has at least one measurement means for measuring the argon concentration in the returned gas flow and/or in the carrier gas. In accordance with the invention, it is provided that the nitrogen of the air is, at least for the most part, replaced by argon and an argon-containing and oxygen-containing carrier gas is supplied to the combustion space and is mixed there as uniformly as possible with the fuel.

By using an oxygen-rich and argon-rich carrier gas, the gas flow rate in the combustion process can be reduced and the energy efficiency of oxidation of the fuel can be distinctly increased. The efficiency increase can be 20% to 60% depending on the load case. In the process according to the invention, the ignition rate and ignition pressure are increased; this leads to a considerable increase of torque. In a motor vehicle, the dynamics of vehicle motion are thus greatly improved. Otherwise, the method according to the invention makes it possible to also use unrefined fuels, such as biofuels, the exhaust gas released in the combustion process being low in pollutants.

Fundamentally, there can also be control of the argon concentration, and the argon concentration can be matched accordingly to the combustion ratios. It is also possible to ensure a higher argon concentration, especially during the starting phase of combustion operation by argon-rich gas from the exhaust gas accumulator being supplied to the carrier gas. This will be explained in detail below.

By using argon as the replacement for nitrogen, the combustion temperature in the combustion space rises. The reason for this is the lower specific heat capacity of argon as compared to nitrogen. In order not to exceed the maximum allowable temperature which is dependent on the temperature resistance of the material used in the combustion space in the combustion of fuel in the combustion space, it is therefore necessary to carry out combustion at a superstoichiometric fuel-carrier gas ratio which should diverge as little as possible from the stoichiometric ratio which is necessary for complete combustion of the fuel used. Measurement of the argon concentration, in this connection, makes it possible to determine the heat capacities of the returned gas flow and/or of the carrier gas, and thus, the combustion temperature in the combustion space. This, of course, assumes that the concentrations of other gas components in the carrier gas are determined or known. The same applies to the mass flows of the gas flow which has been separated and returned from the exhaust gas and of the product gas flow from oxygen recovery.

In one preferred embodiment of the invention, it is provided that the mixing ratio of the returned gas flow, the product gas flow and the volumetric flow of carrier gas supplied to the combustion space are controlled depending on the measured argon concentration such that a given maximum combustion temperature in the combustion space is not exceeded or is reached. According to the apparatus, the combustion unit of the invention has a correspondingly made control means.

Fundamentally, the method according to the invention makes it possible for each load region and load state or load change state of the combustion unit to set the mixing ratio of the argon-rich returned gas flow and oxygen-rich product gas flow as well as the volumetric flow of the carrier gas returned from the combustion space such that for each output requirement of the combustion unit an optimum mixture heat value in the combustion space is obtained. The mixing ratio results from the volumetric flows supplied to the mixing chamber, their temperatures and gas compositions. Control takes place depending on the measured argon concentration.

For an optimum carrier gas-fuel ratio for the purposes of the invention the proportion of ballast components in the carrier gas is fixed at a minimum which is necessary to reliably avoid exceeding the allowable combustion temperatures in the combustion space. For the purposes of the invention, optimum means that the actual carrier gas-fuel ratio in the combustion space is brought as near as possible, preferably with a maximum deviation of 2-5%, to the stoichiometric ratio for complete oxidation of the fuel supplied to the combustion space without the allowable maximum combustion temperatures in the combustion space being exceeded. Here, it can be assumed that the currently allowable combustion temperatures in conjunction with the continued development of the materials used in the field of combustion technology will distinctly increase; this can make it possible to bring the actual mixture heat value closer to the stoichiometric mixture heat value. This can lead to a further increase of energy efficiency.

An optimum mixture heat value of the carrier gas/fuel mixture for the purposes of the invention, depending on the allowable combustion temperature in the combustion space, is associated with a minimum proportion of ballast components, especially nitrogen. The invention here relates to optimization of the gas mixing ratio of the volumetric flows with consideration of the gas temperature, and for each load region, for example, for partial load, medium load and full load operation, for acceleration and deceleration, for cold start or restart and idling, the carrier gas-fuel ratio in the combustion space will be set depending on the amount of fuel supplied to the combustion camber, which amount is matched to the load case. This ratio, with consideration of the maximum allowable combustion temperature, is as near as possible to the stoichiometric carrier gas-fuel ratio without the allowable combustion temperatures being exceeded. The deviation from the stoichiometric carrier gas-fuel ratio should preferably not exceed 2-5%. This leads to optimum fuel energy use and to a reduction of pollutant gas components in the exhaust gas which is as extensive as possible. Optimization is intended to ensure that, in any load region or load state, an oxygen excess as low as possible occurs in the exhaust gas.

In this way, complete oxidation of the fuel in the combustion space and a low concentration of pollutants in the (raw) exhaust gas of the combustion unit are ensured. In this way, complete exhaust gas after-treatment can, for the most part, be eliminated. It goes without saying that, in conjunction with control of the mixing ratio of the returned gas flow and product gas flow, the amount of fuel injected into the combustion space for each load-dependent ratio must be controlled and determined and recorded accordingly. As a result, the carrier gas from the available gas and fuel components is matched to the individual load demand or power demand in its composition by the method according to the invention and the combustion unit according to the invention.

Moreover, the method according to the invention can provide for the recording of characteristics in order to determine an optimum carrier gas/fuel ratio of the combustion unit depending on the composition of the carrier gas for different load states and for different load regions of the combustion unit. Then, the mixing ratio of the returned gas flow and product gas flow in operation of the combustion system can be set accordingly to the determined characteristics in order to obtain a certain gas composition of the carrier gas.

The mixture heat value is the heat value of the carrier gas-fuel mixture and depends on the heat value (energy content) of the fuel and the composition of the carrier gas/fuel mixture. Here, the mixture heat value changes as a function of the carrier gas-fuel ratio. In an internal combustion engine, for example, the mixture heat value of the ignitable carrier gas/fuel mixture is decisive for the output of the internal combustion engine, and not the heat value of the fuel alone. A low heat value of the fuel requires greater amounts of fuel in order to achieve the required output of the internal combustion engine.

Nitrogen, carbon dioxide and water vapor constitute ballast components in the combustion process. The mixture heat value decreases with an increasing proportion of ballast components in the carrier gas. As a result, the mixture heat value of the carrier gas-fuel mixture in the combustion space is essentially defined by the composition of the oxygen-containing carrier gas and by the fuel. The optimization of the mixture heat value provided according to the invention is done by reducing the concentration of ballast components in the carrier gas, especially carbon dioxide, nitrogen and water vapor; however, this is limited by the combustion temperatures which rises with decreasing ballast concentration.

In the method according to the invention, and in the combustion unit according to the invention, first of all, ambient air is separated into a product gas flow enriched with oxygen and argon, on the one hand, and into an exhaust air flow enriched with nitrogen, on the other hand. Preferably, the gas separation system can produce a product gas flow with an oxygen concentration between 22 and 95% by volume, an oxygen and argon concentration of up to 5% by volume. The product gas flow is preferably held in an accumulator, and then, in the mixing chamber of the combustion unit, it is mixed with the gas flow returned from the exhaust gas so that an oxygen-containing carrier gas preferably enriched with oxygen is obtained. The carrier gas and the fuel are then combined in the combustion space. Then, in the combustion space, oxidation of the fuel with the oxygen contained in the carrier gas takes place. The nitrogen-enriched exhaust air flow from the gas separation means is discharged into the vicinity.

A combustion unit for the purposes of the invention is preferably a combustion engine, especially an internal combustion engine for a motor vehicle. However, fundamentally, a combustion unit of the type according to the invention can be any mobile or stationary unit in which fuel is burned with an oxygen-rich carrier gas in a combustion space, and the combustion unit can be operated at varied load. The method according to the invention, moreover, allows use of carbon-containing and/or hydrogen-containing solids, all burnable solids, gases and liquid with high/low heat value, dust and/or marl as combustion materials. The method is not limited to combustion of gasoline, diesel or biofuel. For this reason, the use of the method in industrial combustion processes is possible with, for example, dust or gaseous, solid or liquid fuels.

The gas separation unit is preferably an adsorption means, in the gas separation unit nitrogen being separated from air. Since argon does not participate in combustion, but is an inert gas, with continuous return of the gas flow from the exhaust gas to the mixing chamber, it accumulates in the carrier gas with increasing length of operation of the combustion unit argon. This leads to the argon concentration in the carrier gas being enriched from an initial content of roughly 5% by volume to 75% by volume after the starting phase has been completed. Preferably, the argon concentration in the carrier gas is between 40 to less than 75% by volume after the starting phase has been completed. The oxygen concentration in the carrier gas can be between 10 and 95% by volume, especially between 14 and 93% by volume. For the purposes of the invention, the starting phase is the length of operation of the combustion unit from 1 to 5 minutes, beginning with the first combustion process in the combustion chamber. Depending on the combustion unit, the fuel and the carrier gas are supplied to the combustion space continuously or also discontinuously, i.e., cycled.

The returned gas flow can be obtained by dividing the exhaust gas flow into two component flows, the gas composition in the two component flows being essentially the same and the concentration of argon in the recirculated gas flow corresponding to the concentration of argon in the exhaust gas flow prior to its division. In one alternative embodiment of the method according to the invention, it is conversely provided that the exhaust gas flow is divided into a first argon-enriched component flow and into a second argon-enriched component flow, the recirculated gas flow being formed by a first component flow with a higher argon concentration. In contrast to pure gas return, the recirculating gas flow in this embodiment of the invention has a higher argon concentration and a lower concentration of combustion-induced ballast components. In this way, the efficiency in operation of the combustion unit according to the invention can be further raised.

There can be a control means here to set the argon proportion and/or the volumetric flow of the recirculated first component flow depending on the allowable combustion temperature in the combustion space. By reducing especially the carbon dioxide concentration in the recirculated gas flow, the volumes of the combustion space and the line cross sections of the combustion unit can be still further reduced. The focus here is not only on the slight density differences of the gas components Ar and CO₂, but also on the amount of recirculated exhaust gas flow which has been reduced depending on combustion. Here, the advantage, for process engineering, lies in the reduction of the oxygen-containing and argon-containing carrier gas masses introduced into the combustion space.

Preferably, separation of the exhaust gas flow takes place based on density differences between the gas components in the exhaust gas flow. Here for example separation of argon, carbon dioxide and water vapor is possible based on the existing density differences of these gas components.

The invention is not limited to the embodiments shown in the drawings. All process steps described on the basis of the illustrated embodiments in operation of a combustion unit according to the method according to the invention and the parts of the combustion unit can, if necessary, be implemented or provided regardless of other method steps or unit parts.

### BRIEF DESCRIPTION OF THE DRAWINGS

FIG. 1 is a schematic representation of a first embodiment of a combustion unit according to the invention and

FIG. 2 is a schematic representation of an alternative embodiment of a combustion unit according to the invention.

### DETAILED DESCRIPTION OF THE INVENTION

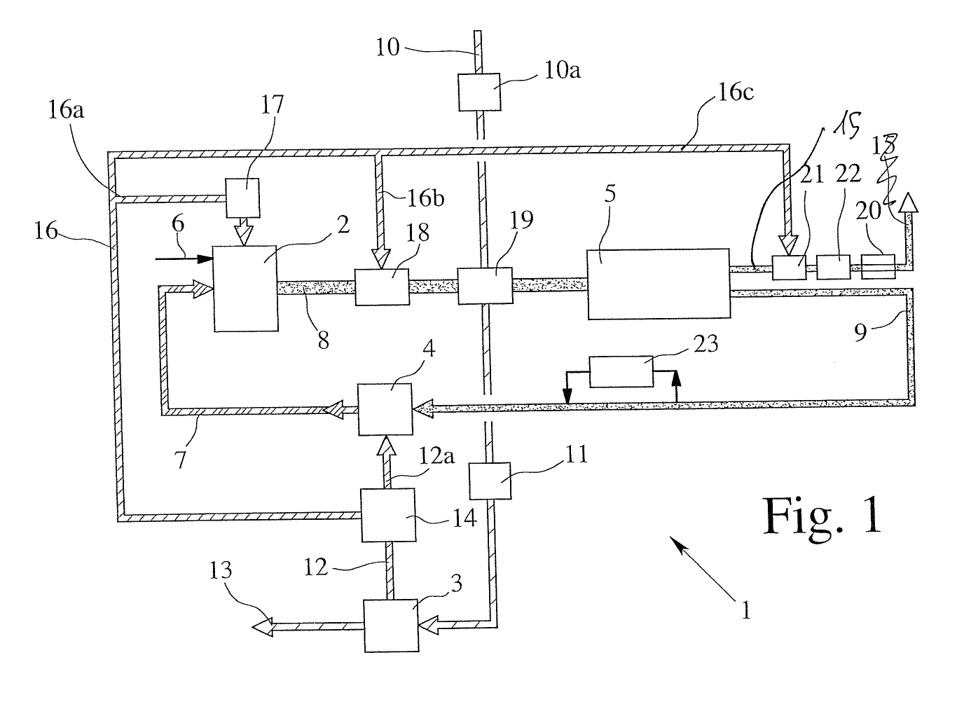

FIG. 1 shows a combustion unit 1 with at least one combustion space 2, at least one gas separation means 3, with at least one mixing chamber 4 and with at least one gas return means 5. In the combustion space 2 of the combustion unit 1a mass flow of a fuel 6 with oxygen-containing carrier gas 7 is burned with release of an exhaust gas flow 8. The exhaust gas flow 8 is divided by means of the gas return means 5 and an argon-rich gas flow 9 is returned to the mixing chamber 4.

Ambient air 10 is taken in via an air filter 10a, compressed with a compressor 11 and separated in the gas separation means 3 into an oxygen-enriched and argon-enriched product gas 12 and into nitrogen-enriched exhaust air 13. The exhaust air 13 is discharged into the vicinity. The product gas 12 is routed from the gas separation means 3 via a line to the product gas accumulator 14 and is stored there. The product gas accumulator 14 for supply of the mixing chamber 4 is connected to the latter via another line. In the mixing chamber 4 the returned gas flow 9 is mixed with the gas flow 12a of the product gas 12 to from a carrier gas 7. Then, the carrier gas 7 is fed into the intake manifold of the combustion space 2.

The product gas 12 which has been released in the gas separation means 3 has an oxygen concentration between 22% and 95% by volume and an argon concentration of roughly 5% by volume. Moreover, the product gas 12 has a low proportion of nitrogen. Since argon as an inert gas does not participate in combustion of the fuel 6 with the carrier gas 7 in the combustion space 2, the argon concentration in the exhaust gas flow 8, and thus also in the carrier gas 7, rises due to the return of the gas flow 9 into the mixing chamber 4 with increasing length of operation of the combustion unit 1, i.e., with increasing duration of combustion of the fuel in the combustion space 2. In this connection, it is pointed out that, as shown in FIG. 1, the gas return means 5 is made only for dividing the exhaust gas flow 8 into a recirculated gas flow 9 and into a residual exhaust gas flow 15 which is discharged into the vicinity. After emerging from the gas return means 5, the two flows 9, 15 initially have the same gas composition.

In the combustion unit 1 shown in FIGS. 1 & 2, there is a measurement means (not shown individually) for measuring the argon concentration in the returned gas flow 9 and/or in the carrier gas 7. The measurement means can, moreover, be made for measuring the gas concentrations of other gas components, especially for measuring the carbon dioxide and water vapor concentration. Otherwise, the oxygen content in the product gas 12, and preferably in the carrier gas 7, is measured. When the gas compositions and the volumetric flows as well as the amount of fuel 6 supplied to the combustion space 2 are known, the maximum allowable combustion temperature which is established in the combustion process in the combustion space 2 can be determined.

For automatic control of the mixing ratio of the recirculated gas flow 9 and the flow 12a of product gas 12 in the mixing chamber 4, and for control of the volumetric flow of carrier gas 7 supplied to the combustion space 2, the combustion unit 1 has a control means (not shown by itself) so that a maximum allowable combustion temperature in the combustion space 2 can be reliably maintained and not exceeded at any instant in the operation of the combustion unit 1.

Moreover, the control means can be made such that, for each load state of the combustion unit 1, an optimum mixture heat value of the carrier gas-fuel mixture in the combustion space 2 is obtained. This also presupposes control of the mixing ratio of the returned gas flow 9 and the product gas flow 12a and control of the volumetric flow of carrier gas 7 supplied to the combustion space 2 depending on the measured argon concentration. It goes without saying that the amount of fuel 6 supplied to the combustion space 2 is likewise controlled. The combustion unit 1 is controlled as a function of the load requirement.

Preferably, the mixing ratio is controlled such that the argon concentration in the carrier gas 7 is between 5% and 75% by volume, especially between 40% by volume and less than 75% by volume and that, preferably, the oxygen concentration in the carrier gas 7 is between 10% and 95% by volume.

As a result of the high combustion temperatures which are established in the combustion process for a stoichiometric carrier gas-fuel ratio, operation of the illustrated combustion unit 1 with a stoichiometric carrier gas-fuel ratio is not easily possible based on the material-induced allowable combustion space temperatures. At a stoichiometric carrier gas-fuel ratio, the volumetric flow of carrier gas is set such that only an amount of oxygen necessary for complete oxidation of the fuel 6 is supplied to the combustion space 2. To reduce the combustion temperatures, however, operation of the combustion unit 1 with a superstoichiometric carrier gas-fuel ratio is provided. The object of optimization is to set the actual carrier gas-fuel ratio in the combustion space 2 to a value which diverges as little as possible from the value of the stoichiometric carrier gas-fuel ratio so that an optimum mixture heat value is achieved and the actual combustion temperature very closely approaches the material-induced maximum allowable combustion temperature.

Not shown is the fact that a partial flow of the product gas 12 can be supplied via the product gas accumulator 14 directly to the carrier gas 7 prior to entry into the combustion space 2. In the illustrated combustion unit 1, however, it is provided that the first component flow 16a of another product gas flow 16 is first stored in a secondary accumulator 17 which is assigned to the combustion space 2, the storage capacity of the secondary accumulator 17 preferably being smaller than the storage capacity of the product gas accumulator 14. The secondary accumulator 17 is in a gas-communicating linkage to the product gas accumulator 14 and can be filled via the product gas accumulator 14. Direct supply of the partial flow 16a or of the product gas to the combustion space 2 can take place by a nozzle means (not shown) and which has specially arranged nozzles and ring nozzles. In this connection, what can be important is specifying short control systems, the line path from the secondary accumulator 17 to the combustion space 2 being less than 20 cm, preferably less than 3 to 10 cm.

The supply of the product gas 12 with an oxygen concentration of up to 95% by volume into the carrier gas 7 by feeding into the intake manifold of the combustion chamber 2 and/or supply of the product gas 12, likewise with an oxygen concentration of up to 95% by volume directly into the combustion space 2, makes it possible to match the composition of the carrier gas-fuel mixture in the combustion space 2 to the brief change of the amount of fuel supplied to the combustion space 2. In this way, for example, load peaks can be equalized and setting of the optimum mixture heat value in each load range of the combustion unit 1 can be ensured. The combustion space 2 is preferably supplied with product gas 12 for sudden load changes and in cold and restart operation.

Downstream of the combustion space 2, there is a combustion chamber 18 for afterburning of the exhaust gas 8. In the combustion chamber 18, combustible components of the exhaust gas flow 8 are burned, and the combustion chamber 18 can be supplied with a second component flow 16b of the other product gas flow 16. Based on the high oxygen concentration of up to 95% by volume in the product gas 12, pollutants and particles contained in the combustion chamber 18 in the exhaust gas flow 8 are largely completely burned.

A turbocharger 19 can be connected downstream of the combustion chamber 18 in order to use the exhaust gas energy of the exhaust gas flow 8 for pre-compression of the ambient air 10.

The exhaust gas flow 8 is divided in the gas return means 5 into the residual exhaust gas flow 15 and into the returned gas flow 9. The volumetric flow of the returned gas flow 9 together with the volumetric flow of the product gas flow 12a which has been supplied to the mixing chamber 4 determines the composition and the volumetric flow of the carrier gas 7. To control the amount of the gas flow 9, there is another control means which is not shown. For example, there can be the schematically shown control member 20 in the line for the residual exhaust gas flow 15 in order to set the volumetric flow of the residual exhaust gas flow 15 released to the vicinity and thus the volumetric flow of the returned gas flow 9.

Moreover, there can be at least one other combustion chamber 21 for re-oxidation of the residual exhaust gas flow 15. A third component flow 16c of the other product gas flow 16 is supplied to the other combustion chamber 21, the oxygen concentration of up to 95% by volume ensuring that particles and pollutants still contained in the exhaust gas as well as components which were not completely oxidized in the nearby combustion chamber 18 are completely re-oxidized. This yields a temperature increase of the residual exhaust gas flow 15 which can then be supplied to a reducing catalytic converter 22 in order to effect reduction of possible nitrogen oxides which are dependent on the load. This ensures that the residual exhaust gas flow 15, upon emerging into the local environment, has essentially no particles, no hydrocarbons and no carbon monoxide. Moreover, the residual exhaust gas flow 15 has a nitrogen oxide concentration which has been reduced by up to 99%.

It is pointed out that the other product gas flow 16, in any case, need not be taken from the product gas accumulator 14. It is also possible for the other product gas flow 16 to be made available directly by the gas separation means 3 or for there to be a further gas separation means 3 to make available the other product gas flow 16. Otherwise, it goes without saying that, if necessary, there can be supply of product gas to the combustion space 2, afterburning of pollutants in the combustion chamber 18, air compression by means of the turbocharger 19 and heating of the residual exhaust gas flow 15 in the further combustion chamber 21 as well as in the reducing catalytic converter 22 so that the structure of the combustion unit 1 is not fixed on the embodiment shown in FIG. 1.

Otherwise, it is not shown that there is temperature control of the residual exhaust gas flow 15 in order to minimize an optionally necessary supply of outside energy for gas heating of the residual exhaust gas flow 15 before entering the reducing catalytic converter 22. Here, it can be provided that the temperature of the residual exhaust gas flow 15 is set to 150° C. to 1000° C., especially to the conversion temperature of the reducing catalytic converter from 200° C. to 400° C. The temperature of the residual exhaust gas flow 15 should be set to the required conversion temperature of the reducing catalytic converter 22 in order to achieve almost complete breakdown of the nitrogen oxides.

In operation of the combustion unit 1, the argon concentration in the exhaust gas flow 8 continuously increases as a result of return of the conditioned argon-containing exhaust gas to the combustion space 2 and the admixture of the argon-containing product gas 12 with increasing length of operation. Therefore, with increasing length of operation, the carrier gas 7 is enriched with argon. In the starting phase of the combustion unit 1, for example, in the first 1 to 5 minutes of combustion of the fuel 6 in the combustion space 2, the argon concentration in the exhaust gas flow 8 is therefore still low. However, so that there is an argon-rich exhaust gas at the start of operation of the combustion unit 1, there is a gas accumulator 23 as a starting reserve for a cold start or restart, the returned gas flow 9 being partially stored in the gas accumulator 23 and the stored gas preferably having an argon concentration of at least 40% by volume, preferably of a maximum 75% by volume. This means that recirculated exhaust gas flows through the gas accumulator 23 after reaching an argon concentration in the recirculated exhaust gas of more than 30% by volume, preferably between 40% and 75% by volume and the accumulator is thus filled for the next starting process. In the starting phase of the combustion unit 1, then argon-rich gas is removed from the gas accumulator 23 and supplied to the mixing chamber 4; this presupposes the corresponding control.

In the illustrated combustion unit 1, moreover, it can be provided that ambient air is automatically supplied to the combustion space 2 when product gas production is disrupted in the gas separation means 3. The fuel 6 is then burned at least partially with the ambient air which has been supplied. A snorkel valve can be provided for air supply of the combustion space 2. By using a snorkel valve, combustion is ensured even when systems engineering fails. Fresh air feed into the combustion space 2 can also be provided and can be necessary when the combustion unit 1 is started after a longer shutdown. Hybrid operation with ambient air 10 and with the carrier gas 7 is also possible.

Finally, it can be provided that the product gas 12 i preheated, preferably the exhaust heat released from the compressor 11 being used in the compression of the ambient air 10 to the operating pressure of the gas separation means 3.

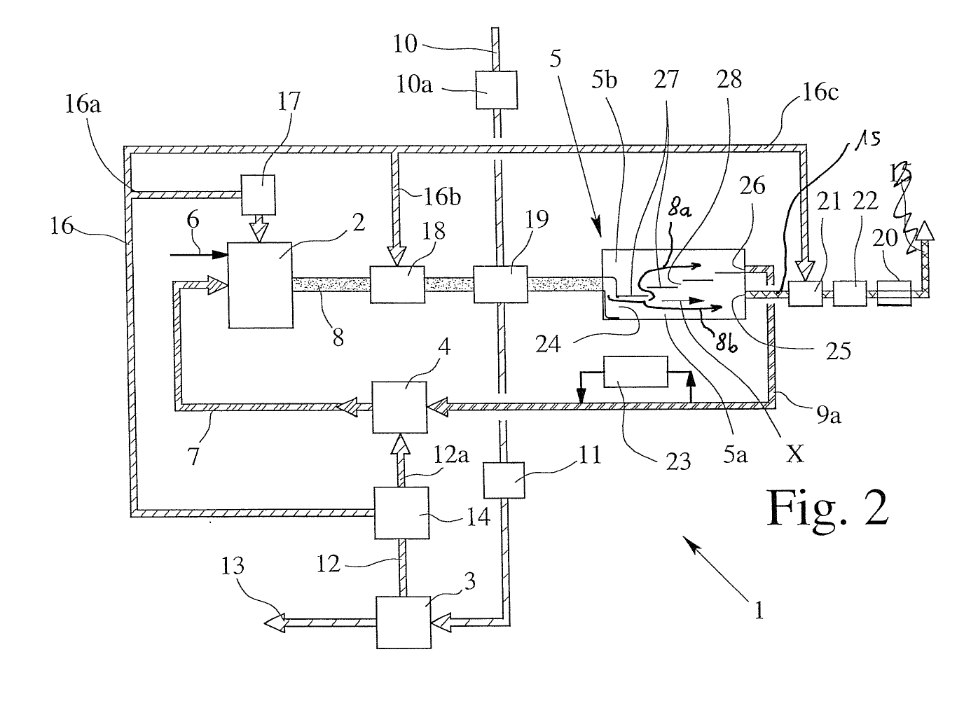

FIG. 2 shows an alternative embodiment of a combustion unit 1 whose structure and unit parts essentially correspond to the structure and parts of the combustion unit 1 shown in FIG. 1. Only the differences between the combustion units 1 shown in FIGS. 1 & 2 are explained in detail below.

In the combustion unit 1 shown in FIG. 2, it is provided that the exhaust gas flow 8 in the gas return means 5 is separated into a first argon-enriched component flow 8a and into a second argon-enriched component flow 8b, a recirculated gas flow 9a being formed by the first component flow 8a. The second component gas flow 8b forms the residual exhaust gas flow 15. In the embodiment shown in FIG. 2, it is now provided that at least two gas components in the exhaust gas flow 8, preferably argon, carbon dioxide, water/water vapor and possible nitrogen oxide components, are separated due to the existing density differences between the aforementioned components. The gas return means 5 is made as a separating tank which is cooled on one half side, the separating tank having a lower cold zone region 5a and a warm zone region 5b located above it. An entry opening 24 discharges into the cold zone region 5a. Moreover, the cold zone region 5a and the warm zone region 5b each have at least one exit opening 25, 26 for the component flows 8a, 8b.

The cold zone region 5a is separated from the warm zone region 5b by a plurality of baffles 27 which are arranged in succession in the manner of a cascade in the through-flow direction X of the separating tank. The baffles 27 are arranged preferably running transversely to the through-flow direction X in the tank and extend in the lengthwise direction from one side of the jacket surface of the separating tank to the opposite side of the jacket surface. Otherwise, the baffles 27 are arranged essentially parallel to one another, in the flow direction X, adjacent baffles 27 having an increasing distance from the bottom so that a rising cascade results. Between the adjacent baffles 27, there are through-flow openings 28 so that the gas components with comparatively lower density, such as, for example, argon, can rise out of the exhaust gas flow 8 past the baffles 27 into the warm zone region 5b. In the warm zone region 5b the higher temperature intensifies buoyancy so that the lighter gas components accumulate in the warm zone region 5b and can be withdrawn via the exit opening 26. Since carbon dioxide has a higher density than argon, in operation of the combustion unit 1 the argon rises and thus accumulates in the warm zone region 5b so that the recirculated gas flow 9a has a higher argon concentration than the residual exhaust gas flow 15 which is discharged via the exit opening 25. The baffles 27 act here as a barrier for the heavier gas molecules so that the cold zone region 5a constitutes essentially a cold trap for the heavier gas components of the exhaust gas flow 8. The separation of gas components is based on the different temperature, velocity of the molecules of the individual gas components.

Gas separation of different gas components takes place by the differing reduction of the gas molecule velocity or oscillation rate of the gases in the cold zone region 5a relative to the warn zone region 5b. The separating tank here constitutes a cooling trap which is formed on one side. The separating tank is cooled with cooling water with a temperature from 80° C. to 120° C., so that the exhaust gas flow 8 in the cold zone region 5a has a temperature from roughly 400° C. to 900° C., especially of roughly 500° C. The temperature of the exhaust gases should not fall below the conversion temperature of the reducing catalytic converter and should preferably be roughly 400° C. so that a sufficient reaction temperature for the downstream reducing catalytic converter 22 is maintained.

Otherwise, it is not shown in particular that separation of the exhaust gas flow 8 can also take place in the turbocharger 19, the exhaust gas flow 8 being supplied to the turbocharger 19 and being separated into two component flows according to the principle of a centrifugal force separator in the housing of the turbocharger 19. Due to the high peripheral speeds, heavier gas components with a higher density such as, for example, carbon dioxide, water and nitrogen components, accumulate in the region of the housing near the wall and can be withdrawn via at least one removal site in the housing. The component flow with the heavier gas components can be removed distributed uniformly over the periphery of the housing via an annular groove, and the annular groove can be continuously evacuated and the component flow discharges either into the vicinity or can be conditioned in exhaust gas after-treatment.

Controlled gas removal of the turbocharger 19 should be provided between a high pressure part (inflow region) and a low pressure part (outflow region) of the turbocharger 19. The basis for removal from the turbocharger 19 is the different density of the gas molecules in the exhaust gas flow 8 which changes accordingly depending on temperature. In this connection it can be provided that the turbocharger 19 is made in several stages.

By separating heavier gas components, the argon concentration of the exhaust gas flow 8 increases in flow through the turbocharger 19 so that preferably the use of another gas return means 5 in this case is not necessary. The exhaust gas flow 8 is then recirculated directly to the mixing chamber 4 after flow through the turbocharger 19.

Advantageous operation of the combustion unit 1 according to the invention at medium rpm and in roughly static operation (rpm constant) is possible at the following concentrations of the gas components:

| | | | | | | | Fuel 7 |
|---|---|---|---|---|---|---|---|
| | | | | | | | 86% by |
| | O₂ | Ar | N₂ | CO₂ | H₂O | NOₓ | weight C |
| | [% by | [% by | [% by | [% by | [% by | [% by | 14% by |
| | vol.] | vol.] | vol.] | vol.] | vol.] | vol.] | weight H |
| Ambient air 10 | 21 | 1 | 78 | — | Traces | — | — |
| Exhaust air 13 | 9.5 | 0.5 | 90 | — | — | — | — |
| Mixing | 25 | 50 | 2 | 21 | 3 | 2 | — |
| chamber 4 | | | | | | | |
| Product gas | 93 | 5 | 2 | — | — | — | — |
| accumulator 14 | | | | | | | |
| Secondary | | | | | | | |
| accumulator 17 | | | | | | | |
| Combustion | 23 | 51 | 2 | 10 | 2 | 1 | 11 |
| space 2 | | | | | | | |
| Exhaust gas | — | 45 | — | 43 | 7 | 5 | — |
| flow 8 | | | | | | | |
| downstream of | | | | | | | |
| turbocharger 19 | | | | | | | |
| Gas | — | 65 | — | 33 | Traces | 2 | — |
| accumulator 23 | | | | | | | |
| Residual | — | 20 | — | 68 | 10 | 2 | — |
| exhaust | | | | | | | |
| gas flow 15 | | | | | | | |

What is claimed is:

1-41. (canceled)

42. Method for operating a combustion unit, comprising the steps of:
burning a fuel in at least one combustion space with an oxygen-containing carrier gas with the release of an exhaust gas flow,
separating ambient air into a product gas flow which is enriched with oxygen and into exhaust air flow enriched with nitrogen,
separating a gas flow from the exhaust gas flow and returning the separated gas flow to the combustion space, the returned separated gas flow being mixed with a the product gas flow to form a carrier gas,
separately supplying the carrier gas and fuel separately to the at least one combustion space,
measuring the concentration of argon in at least one of the returned gas flow and in the carrier gas, supplying a partial flow of the product gas directly to the carrier gas prior to entry into the combustion space or supplying another product gas flow directly to the combustion space for matching the composition of the carrier gas-fuel mixture in the combustion space to the brief change of the amount of fuel supplied to the combustion space,
wherein the mixing ratio of the returned gas flow and of the product gas flow and the volumetric flow of the carrier gas supplied to the combustion space and said other product gas flow which is supplied directly to the combustion space are controlled depending on the argon concentration measured such that for each load state of the combustion unit, an optimum mixture heat value of the product gas/carrier gas-fuel mixture in the combustion space is obtained.

43. Method as claimed in claim 42, wherein the product gas flow is stored in at least one product gas accumulator and wherein said product gas flow and said other product gas flow are taken from said gas accumulator.

44. Method as claimed in claim 42,
wherein the exhaust gas flow is separated into a first argon-enriched component flow and into a second argon-depleted component flow as the residual exhaust gas flow, and
using the first component flow to form the returned gas flow.

45. Method as claimed in claim 44, wherein separation takes place in a separating tank which is cooled on one half side, the exhaust gas flow flowing into a cold zone region of the separating tank, the exhaust gas flow being cooled in the cold zone region, wherein an upward flow of at least one gas component out of the cold zone region into a warm zone region of the separating tank located above is effected by density differences between the gas components in the exhaust gas flow and wherein the first component flow in the warm zone region and the second component flow in the cold zone region are discharged from the separating tank.

46. Method as claimed in claim 42, wherein said other product gas flow is stored in a secondary accumulator which is assigned to the combustion space.

47. Method as claimed in claim 44, wherein separation takes place in a turbocharger, the exhaust gas flow being supplied to the turbocharger and being separated into two component flows by centrifugal force in a housing of the turbocharger and wherein the two component flows are discharged from the turbocharger separately from one another.

48. Method as claimed in claim 42, wherein afterburning of the exhaust gas of the exhaust gas flow takes place in at least one combustion chamber connected downstream of the combustion space, the combustion chamber being supplied with product gas.

49. Method as claimed in claim 42, wherein ambient air is automatically supplied to the combustion space when product gas generation is disrupted.

50. Combustion unit, comprising:
at least one combustion space for burning a fuel with an oxygen-containing enriched carrier gas and releasing of an exhaust gas flow,
at least one gas separation means for separating ambient air into an oxygen-enriched product gas flow and exhaust airflow enriched with nitrogen,
at least one mixing chamber, and
at least one gas return means, in the combustion space,
a gas return means for separating a return gas flow from the exhaust gas flow which is returned to the combustion space,
a mixing chamber for mixing the returned gas flow with the product gas flow to form the carrier gas,
means for supplying the carrier gas and fuel separately to the combustion space,
at least one measurement means for measuring the concentration of argon in at least one of the returned gas flow and the carrier gas,
wherein there is at least one product gas accumulator for product gas
and wherein at least one secondary accumulator for product gas is assigned to the at least one combustion space and is located in an immediate vicinity of the combustion space.

51. Combustion unit as claimed in claim 50, further comprising an automatic control means for automatically controlling the ratio of the returned gas flow and the product gas flow in the carrier gas and for controlling the volumetric flow of carrier gas supplied to the combustion space depending on the measured argon concentration.

52. Combustion unit as claimed in claim 50, wherein the secondary accumulator is fillable by the product gas accumulator.

53. Combustion unit as claimed in claim 50, wherein the combustion space has at least one nozzle means for directly supplying product gas into the combustion space.

54. Combustion unit as claimed in claim 50, wherein a combustion chamber for afterburning of the exhaust gas flow is located downstream of the combustion space.

55. Combustion unit, comprising:
at least one combustion space for burning a fuel with an oxygen-containing enriched carrier gas and releasing of an exhaust gas flow,
at least one gas separation means for separating ambient air into an oxygen-enriched product gas flow and exhaust airflow enriched with nitrogen,
at least one mixing chamber, and
at least one gas return means, in the combustion space,
a gas return means for separating a return gas flow from the exhaust gas flow which is returned to the combustion space,
a mixing chamber for mixing the returned gas flow with the product gas flow to form the carrier gas,
means for supplying the carrier gas and fuel separately to the combustion space, and
a turbocharger for separation of the exhaust gas flow into a first argon-enriched component flow and into a second argon-depleted component flow by centrifugal force.

56. Combustion unit, comprising:
at least one combustion space for burning a fuel with an oxygen-containing enriched carrier gas and releasing of an exhaust gas flow,
at least one gas separation means for separating ambient air into an oxygen-enriched product gas flow and exhaust airflow enriched with nitrogen,
at least one mixing chamber, and
at least one gas return means, in the combustion space,
a gas return means for separating a return gas flow from the exhaust gas flow which is returned to the combustion space,
a mixing chamber for mixing the returned gas flow with the product gas flow to form the carrier gas,
means for supplying the carrier gas and fuel separately to the combustion space,
wherein the at least one gas return means is a separating means with a separating tank which is cooled on one half side, the separating tank having a lower cold zone region and an upper warm zone region, wherein an entry opening of the separating tank discharges into the cold zone region, and wherein the cold zone region and the warm zone region each have at least one exit opening and being connected to one another via at least one gas-communicating linkage.

57. Combustion unit as claimed in claim 56, wherein the separating tank has a plurality of baffles which are arranged in succession in the manner of a cascade in a through-flow direction of the separating tank, the baffles being arranged spaced apart from one another in the separating tank and the cold zone region being separated from the warm zone region by the baffles in sections transversely relative to the throughflow direction.
